(19) United States
(12) Patent Application Publication
(10) Pub. No.: US 2026/0064490 A1
(43) Pub. Date: Mar. 5, 2026

(54) CLUSTERING FRAMEWORK FOR DISTRIBUTING WORKLOADS ACROSS NODES OF A CLUSTER

(71) Applicant: ITRON, INC., Liberty Lake, WA (US)

(72) Inventors: Christopher MOCK, Garner, NC (US); Joseph MARTIN, Raleigh, NC (US)

(21) Appl. No.: 18/820,064

(22) Filed: Aug. 29, 2024

(51) Int. Cl. G06F 9/50

(52) U.S. Cl. CPC G06F 9/5083; G06F 9/5072

(57) ABSTRACT

Various embodiments disclose a method comprising obtaining, by a node in a cluster of nodes, a message from a messaging queue; determining, by the node, a shard within the cluster that corresponds to the message based upon an identifier included in the message; determining, by the node, a responsible node associated with the shard; and forwarding, by the node, the message to the responsible node, wherein the responsible node delivers the message to a destination.

### BACKGROUND

### Field of the Various Embodiments

The various embodiments relate generally to distributing computing workloads, and more specifically, to a clustering framework for distributing workloads across nodes of a cluster.

### Description of the Related Art

Computing workloads are often distributed across nodes of a cluster. Nodes represent servers, virtual machines, or containers that execute workloads on behalf of clients of the cluster. In some cases, certain nodes of a cluster can become overloaded when workloads are not evenly distributed across the cluster. For example, in the case of a cluster that processing messages that are exchanged between a message sender and a message destination, if a minority of nodes are assigned more messages for processing than others, the performance of the cluster suffers. Additionally, resources assigned to underutilized nodes of the cluster are wasted if the nodes do not process as many messages as possible according to the allocated resources.

### BRIEF DESCRIPTION OF THE DRAWINGS

So that the manner in which the features of the various embodiments can be understood in detail, a description of the inventive concepts may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a networked environment handling a message, according to various embodiments.

FIG. 2 illustrates a block diagram of a computing system including a cluster of nodes, according to various embodiments.

FIG. 3 illustrates a node, according to various embodiments.

FIG. 4 illustrates a client, according to various embodiments.

FIG. 5 is a flow diagram of method steps for a node routing requests within the cluster, according to various embodiments.

FIG. 6 is a flow diagram of method steps for a node joining a cluster, according to various embodiments.

FIG. 7 is a flow diagram of method steps for a node receiving and processing updated cluster status information, according to various embodiments.

FIG. 8 is a flow diagram of method steps for a node issuing heartbeat requests to a reporting node, according to various embodiments.

FIG. 9 illustrates a network system configured to implement one or more aspects of the various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

Utility meters are typically deployed across a utility provider’s territory and include thousands of meters deployed across a region. The meters in a utility metering environment electronically record the consumption of utility commodities, such as water, electricity, heat, and gas, and transmit metrology data indicative of the recorded commodity consumption to other devices, such as an upstream system utilized by the utility operator. For example, for billing purposes, a smart utility meter transmits metrology data indicative of consumption of a utility commodity to a remote computing device of a utility provider. In some environments, a utility might deploy thousands of meters that are reporting metrology data in messages sent to back-office systems for monitoring and billing purposes. Processing these messages requires significant computing resources from back-office systems. Therefore, embodiments of the disclosure can distribute workloads tasked with sending outbound messages to meters and processing inbound messages from meters across a cluster. Embodiments of the disclosure are also applicable to other scenarios in which computing workloads are distributed across a cluster.

As will be described herein, computing workloads are often executed in clusters of one or more servers, virtual machines, or containers. The servers, virtual machines, or containers of a cluster are referred to as nodes of the cluster. Clients of the cluster are devices or processes that request execution of a service or computing resources from the cluster. In one example, the nodes of the cluster perform message routing between various actors in a utility metering environment. Meters, or other endpoints, can send messages that include metrology data to meter infrastructure management systems. Additionally, meter infrastructure management systems send messages to meters that are deployed in the field to manage, update, or otherwise communicate with the meters. Examples of the disclosure distribute workloads that process outgoing and incoming messages across a cluster for load balancing purposes. Embodiments of the disclosure distribute workloads across a cluster based on the identity of a message destination or the identity of a sender. The identity can be based upon a device identifier, such as an International Mobile Equipment Identity (IMEI) number or another identifier that uniquely identifies the sender or destination of a message.

In examples of the disclosure, devices such as meters are assigned to various shards based upon the device identifier of the meter. In one example, the modulus of a hash of the device identifier or another input to a hash function operates as a shard identifier to which the meter is assigned. The nodes of the cluster are assigned respective shards to distribute the workloads across the cluster.

When a client submits a request to transmit a message to a destination, such as a meter or a back-office server that manages meters deployed in a utility infrastructure, the request is retrieved by a node. The node determines which node in the cluster is assigned to a shard corresponding to an identifier associated with the message. In one example, the request is placed into a queue within the cluster, and a node within the cluster retrieves the request from the queue. If the node determines that the request is associated with a shard that is the responsibility of the node, then the node retrieving the request from the queue performs the requested computing operations, such as routing a message to a destination. If the node determines that the request is associated with a different shard, then the node routes the request to the appropriate node via a remote procedure call, and the appropriate node performs the requested computing operations. In some implementations, a client can maintain status information about the assignment of nodes to shards within the cluster and determine to which node a request should be sent. In this scenario, a client can directly submit a request to a node assigned to the appropriate shard.

At least one technical advantage of the disclosed embodiments is the simplicity of implementation. Workloads can be associated with an identifier of a meter or other type of endpoint device. As a result, workloads are efficiently assigned to a shard within a cluster. In addition, nodes of the cluster can efficiently and accurately determine which node within a cluster should receive a workload to perform. Another technical advantage of the disclosed embodiments is that few external dependencies are needed to effectively distribute workloads among nodes. Another technical advantage of the disclosed embodiments is that a cluster of nodes according to the disclosure is self-governing and does not need a leader node in order to operate effectively.

### Balancing Workloads across a Cluster of Nodes

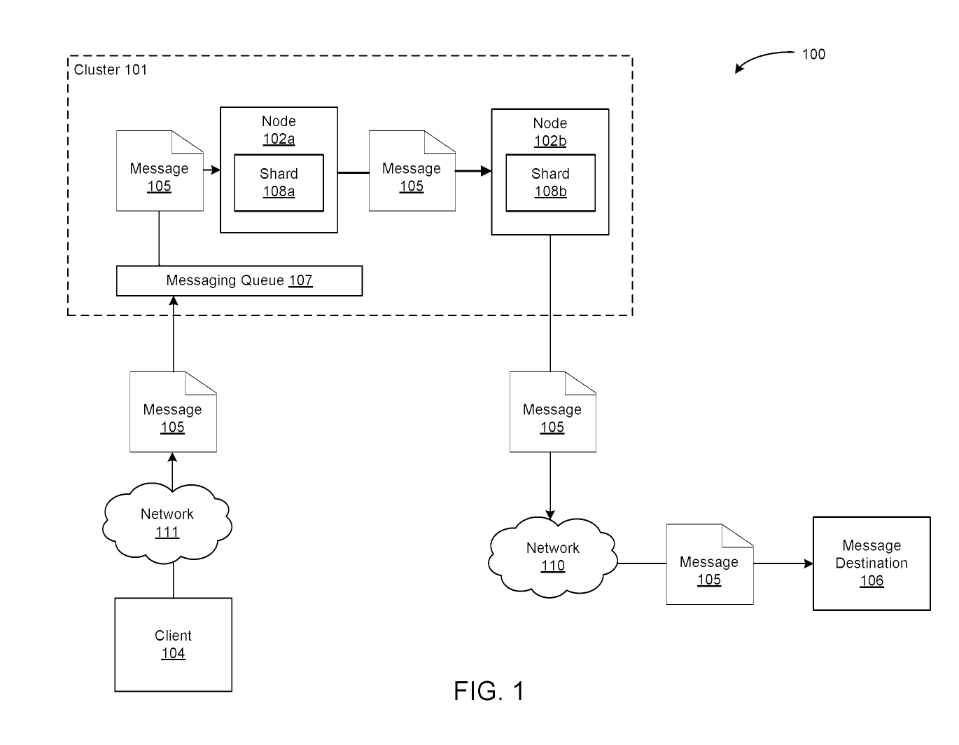

FIG. 1 illustrates a block diagram of a network environment 100 handling a message, according to various embodiments. As shown in FIG. 1, networked environment 100 includes, without limitation, a cluster 101 of one or more nodes 102, a client 104, a message destination 106, a messaging queue 107, a network 110, and a network 111. A node 102 includes, without limitation, shards 108. In the scenario of FIG. 1, client 104 submits a message 105 for delivery to message destination 106 via network 110. The message destination 106 is representative of a device to which message 105 is addressed. For example, message destination 106 could include a meter deployed in a utility metering environment to which a meter infrastructure management system is sending message 105. In this scenario, the meter infrastructure management system is the client 104 of the cluster 101 and communicates with the cluster 101 via network 111, which can be the same as network 110 or a different network. A message destination 106 could also include the meter infrastructure management system to which a meter is sending information such as metrology data. In this latter scenario, the meter is client 104.

A cluster 101 of nodes 102 represents a plurality of servers, virtual machines, or containers that execute one or more workloads. In one implementation, the nodes 102 of a cluster 101 are communicatively coupled via a network (not shown). A workload represents a service, or other software process that performs work on behalf of clients 104 of the cluster 101. For example, a client 104 sends a message 105 to a message destination 106 utilizing the cluster 101 to perform computing and network operations necessary to complete delivery of the message 105. Processing of the message 105 by a node 102 of the cluster 101 represents a workload that is distributed across the cluster 101. In one scenario, a message 105 is sent by a meter infrastructure management system (in the role of client 104) to a meter (in the role of message destination 106) by submitting the message to the cluster 101. A node 102 within the cluster 101 processes the message 105 and forwards the message to a message destination 106 via network 110. Similarly, a meter (in the role of client 104) in a utility metering environment can also send a message 105 to a meter infrastructure management system (in the role of message destination 106) by sending the message to the cluster 101, where a node 102 assigned to process messages on behalf of the sender or the destination of the message forwards the message 105 to the meter infrastructure management system.

A node 102 is assigned to one or more shards 108. A shard 108 within the cluster 101 represents a logical segment of an overall population of work that can be performed by the cluster 101 and that is assigned to a respective node 102. Each respective assignment or task from the overall population of work is determined by an identifier of a respective assignment. For example, node 102a is assigned to handle tasks associated with a first set of message destinations 106 deployed in the networked environment 100 based on an identifier the respective message destination 106. Node 102b is assigned to handle tasks associated with a second set of message destinations 106 based on respective identifiers of the message destinations 106 such that all tasks associated with the second set of message destinations 106 are handled by node 102b. In an example scenario, any incoming or outgoing message 105 associated with a message destination 106 from the first set of message destinations 106 is handled by node 102a, and any message associated with a different message destination 106 from the second set of message destinations 106 is handled by node 102b. In this example, the first set of message destinations 106 is associated with a shard 108a assigned to node 102a, and the second set of message destinations 106 is associated with a shard 108b assigned to node 102b. In one example, assignment of tasks to a particular shard 108 is determined by a mathematical operation. For example, a modulus operation is performed on an identifier of a message destination 106 and/or of an identifier of a sender of the message. The result of the modulus operation is an integer that is used to identify a shard 108.

In the example of FIG. 1, a client 104 sends a message 105 to the cluster 101. When the message 105 is received by the cluster 101, the message 105 is placed into the messaging queue 107 utilized by the cluster 101. Node 102a retrieves the message 105 from the inbound message queue and determines whether it is the node 102 assigned to a shard 108 corresponding to the message destination 106 specified in the message 105. In some implementations, the node 102a retrieves the message 105 from the messaging queue 107 in response to the messaging queue 107 randomly assigning the message 105 to the node 102a. In some examples, the nodes 102 of the cluster 101 take turns retrieving messages 105 from the messaging queue 107 provided by the node 102. In some examples, the client 104 transmits message 105 directly to the node 102a by randomly selecting the node 102a from among nodes 102 in the cluster 101.

Upon retrieving the message 105 from the messaging queue 107 of the cluster 101, node 102a determines whether the message 105 is associated with the shard 108a assigned to node 102a. Node 102a determines whether the message 105 is associated with the shard 108a assigned to node 102a by performing a modulus operation on an identifier of the message destination 106. In the depicted example, based on the result of the modulus operation, node 102a determines that the message 105 is assigned to the shard 108b for which node 102b is responsible. Therefore, node 102a forwards the message 105 to node 102b via an inter-process communication message or a remote procedure call that invokes one or more functions in the node 102b to process the message 105. Upon receiving the message 105 from node 102a, node 102b determines that the message 105 is associated with the shard 108b assigned to node 102b.

Node 102b forwards the message 105 to the message destination 106, such as a meter in a utility metering environment, via the network 110. Node 102b executes services or applications that are configured to communicate with a network 110 on which the message destination 106 is deployed, such as a wireless cellular network, to enable communication with the message destination 106 on behalf of the client 104. Accordingly, by utilizing shards 108 to perform tasks among the nodes 102 of a cluster 101, examples of the disclosure balance workloads across the cluster 101.

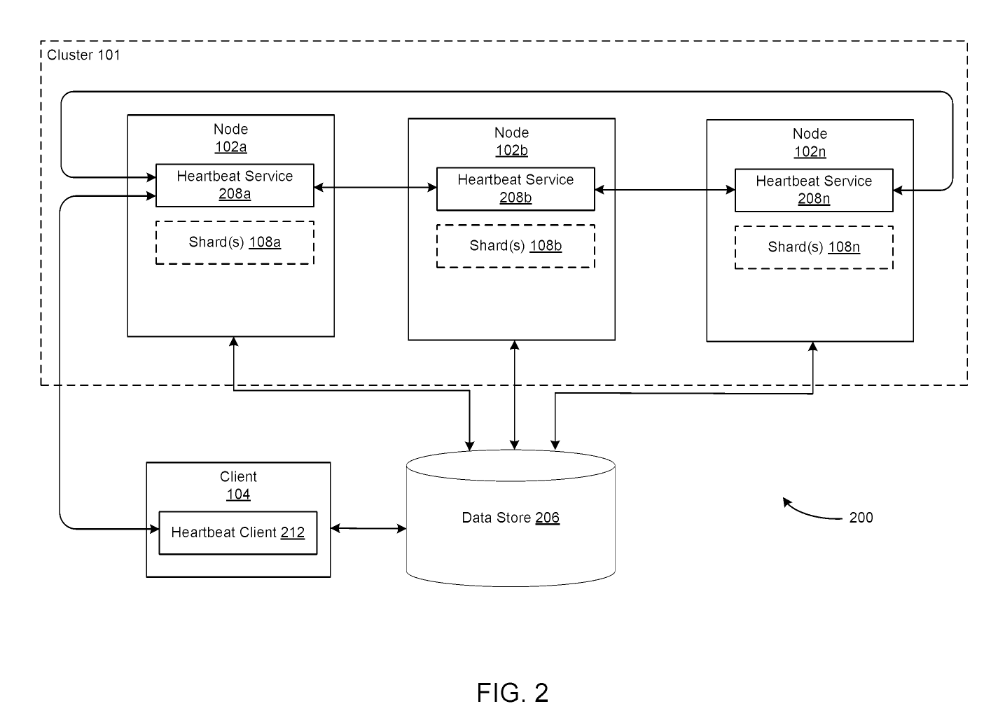

FIG. 2 is a block diagram of a computing system including a cluster of nodes, according to various embodiments. As shown in FIG. 2, networked environment 200 includes, without limitation, cluster 101 of one or more nodes 102, one or more clients 104, and a data store 206. In addition to storing one or more shards 108, a node 102 executes, without limitation, a heartbeat service 208. A client 104 executes, without limitation, a heartbeat client 212. The data store 206 stores, without limitation, cluster data, which comprises information about the cluster 101. Although only three nodes 102 and a single client 104 are illustrated, it should be appreciated that a cluster 101 can include any number of nodes 102 and that multiple clients 104 can communicate with nodes 102 of the cluster 101.

A node 102 is assigned to one or more shards 108. As noted above, a shard 108 within the cluster 101 represents a logical segment of an overall population of work that can be performed by the cluster 101 and that is assigned to a respective node 102. Each respective assignment or task from the overall population of work is determined by an identifier of a respective assignment. For example, node 102a can be assigned to handle tasks associated with a first set of meters deployed in a utility metering environment based upon the IMEI of the respective meters such that all tasks associated with the first set of meters is handled by node 102a. Node 102b can be assigned to handle tasks associated with a second set of meters based on the IMEI of the second population of meters such that all tasks associated with the second set of meters are handled by node 102b. In an example scenario, any inbound or outbound message associated with a first meter from the first set of meters is handled by node 102a, and any message associated with a second meter from the second set of meters is handled by node 102b. In one example, assignment of tasks to a particular shard 108 is determined by a mathematical operation. For example, a modulo operation can be performed on the IMEI or other identifier of a meter. The result of the modulo operation is an integer that is used to identify a shard 108. In other implementations, any other function or mathematical operation, such as a hash function, that repeatably outputs the same value for a given input, can be utilized to determine a shard 108 to which task is assigned.

The heartbeat service 208 enables detection of node failure as well as changes in the configuration of the cluster 101. Each node 102 selects a reporting node 102 from which the node 102 requests periodic status information, or a heartbeat message, including data about the health of the reporting node 102 as well as a generation identifier of the cluster 101. The generation identifier also represents a current version of the cluster 101 to help node 102 determine if the cluster 101 has recently changed. In one example, each node 102 in the cluster 101 reports status information to a single other node 102 in the cluster 101, referred to herein as a peer node 102. Additionally, assuming there are more than two nodes 102 in cluster 101, the peer node 102 and reporting node 102 are different nodes 102. In other words, each node 102 receives status information from a reporting node 102 and reports status information to a peer node 102. In this way, nodes 102 report status information to each other about the health and status of the cluster 101 in a circular peer-to-peer fashion. If a reporting node 102 from which a node 102 receives status information stops reporting status information for longer than a configurable timeout period, the heartbeat service 208 reports the failure of the reporting node 102 to the data store 206 The heartbeat service 208 updates the data store 206 to reflect the failure of the reporting node 102 by removing the failed node 102 from the assignment of shards 108 and updating the generation identifier of the cluster 101. In one example, heartbeat service 208 increments a numerical identifier that represents the generation identifier in the data store 206. Additionally, removing the failed node 102 from the assignment of shards 108 in the data store 206 results in the shards previously assigned to the failed node 102 becoming unclaimed.

The updated generation identifier is reported to other nodes 102 in the cluster 101 in a peer-to-peer fashion by the heartbeat service 208 running on the nodes 102. When other nodes 102 of the cluster 101 receive the updated generation identifier, the respective heartbeat service 208 executing on the nodes 102 obtains cluster data including information about the other nodes 102 in the cluster 101 as well as the assignment of shards 108 from the data store 206. If a node 102 within the cluster 101 has not been assigned a maximum number of shards 108, the node 102 can also claim one or more shards 108 that are indicated as unclaimed or orphaned in the data store 206. Accordingly, the heartbeat service 208 running on nodes 102 of the cluster 101 allows the cluster 101 to self-detect node failure and allows the nodes 102 of the cluster 101 to reassign shards 108 to themselves subject to a shard assignment maximum policy that is specified in the data store 206. The shard assignment maximum policy prevents any one node 102 from becoming overloaded with requests from clients 104 of the cluster 101.

The heartbeat service 208 executed by a respective node 102 also adds the node 102 to the cluster 101. In other words, the heartbeat service 208 enables nodes 102 to effectively add themselves to the cluster 101. For example, the heartbeat service 208 adds a node 102 to the cluster 101 by adding an identifier corresponding to the node 102 to a listing of nodes 102 in the cluster data stored in the data store 206. The listing of nodes 102 can include a network address of the node 102 as well as a unique alphanumeric identifier of the node 102 that is assigned by an administrator or generated by the heartbeat service 208. The unique identifier associated with a node 102 can include a hostname in combination with a timestamp. Each time a node 102 restarts, the unique identifier of a node 102 is updated by the node 102 upon startup. The heartbeat service 208 also determines whether adding a node 102 to the listing of nodes 102 within the data store 206 was successful. In some instances, multiple nodes 102 can attempt to update the cluster data in the data store 206 simultaneously. If the heartbeat service 208 was unsuccessful in adding the node 102 to the cluster 101, the heartbeat service 208 can wait a random amount of time and retry adding the node 102 to the cluster 101.

In one example, the heartbeat service 208, once adding the node 102 to the cluster 101, identifies unclaimed shards 108 in the data store 206 and claims the shards 108 on behalf of the node 102. The cluster data specifies a maximum number of shards 108 that can be claimed by a particular node 102 in a shard assignment maximum policy. Heartbeat service 208 claims shards 108 on behalf of a node 102 by updating a table or listing in the data store 206 that identifies shards 108 by a shard identifier and an identifier of a node 102 to which respective shards 108 are assigned. Heartbeat service 208 updates the listing of shards 108 to indicate that the node 102 on which the heartbeat service 208 is running is now assigned to a given shard 108. The heartbeat service 208, in addition to claiming one or more shards 108 on behalf of a node 102, updates the generation identifier of the cluster 101 once the shards 108 have been claimed. Once claimed, any subsequent requests sent to the cluster 101 that are associated with the claimed shard 108 are routed to the node 102 that claimed the shard 108.

Once a node 102 has added itself to the cluster 101, heartbeat service 208 also selects a new peer node 102. Heartbeat service 208 initiates peer node 102 selection throughout the cluster 101 by updating the generation identifier indicating a change in the cluster 101. When other nodes 102 in the cluster 101 detect an updated generation identifier, the heartbeat service 208 executing on the respective nodes 102 select a new peer node 102 because the new generation identifier indicates that the state of the cluster 101 has changed. As noted above, a peer node 102 represents another node 102 in the cluster 101 to which a given node 102 reports status information. Status information can include a ping or heartbeat message indicating that the node 102 is operating as well as a current generation identifier of the cluster 101 that is known to or stored by the heartbeat service 208 running on the node 102. Status information can also include an error code in the event that a node 102 can communicate but can no longer operate as a node 102 within the cluster 101. In one embodiment, heartbeat service 208 selects a peer node 102 by sorting the listing of nodes in the data store 206 numerically or alphabetically by identifier and selecting a next or previous node 102 in the sorted list relative to itself as its peer node 102. If heartbeat service 208 is configured to select the next node 102 in the sorted list as its peer node 102 and if a given node 102 is the last node 102 in the sorted list, heartbeat service 208 selects the first node 102 in the sorted list as its peer node 102. If heartbeat service 208 is configured to select the previous node 102 in the sorted list as its peer node 102 and if a given node 102 is the first node 102 in the sorted list, heartbeat service 208 selects the last node 102 in the sorted list as its peer node 102. By selecting a next or previous node 102 as a peer node 102, each node 102 in the cluster 101 has a different peer node 102 and a different reporting node 102.

As noted above, heartbeat service 208 receives status information from a reporting node 102 and reports failure of the reporting node 102 to the data store 206. Heartbeat service 208 detects failure of a reporting node 102 if the reporting node 102 has failed to report status information after a specified period of time. Heartbeat service 208 also detects failure of a reporting node 102 if the reporting node 102 reports an error that indicates that the reporting node 102 can no longer operate as a node 102 within the cluster 101 or otherwise service the shards 108 assigned to the reporting node 102. In one implementation, heartbeat service 208 issues a heartbeat request or ping request to a reporting node 102 periodically. Heartbeat service 208 running on the reporting node 102 responds to the ping request with a heartbeat message indicating that the node 102 is operating. The response to the heartbeat request also includes the generation identifier of the cluster 101 that heartbeat service 208 running on the reporting node 102 has most recently obtained from the data store 206. If no response to the heartbeat request is received within a specified period of time, heartbeat service 208 considers the reporting node 102 to have failed. Upon detecting failure of a node 102, heartbeat service 208 updates the status of the reporting node 102 as failed in the data store 206 and further updates the assignment of shards 108 that were previously assigned to the reporting node 102 as orphaned or unclaimed. Heartbeat service 208 further updates the generation identifier of the cluster 101 within the data store 206 to indicate a change in the cluster 101. Heartbeat service 208 also initiates selection of a new peer node 102 within the cluster 101 as described above.

If a reporting node 102 is operating and reports status information to the heartbeat service 208 running on a peer node 102 that includes a generation identifier that is different from the generation identifier stored by heartbeat service 208 on the peer node 102, the heartbeat service 208 on the peer node 102 determines that a change in the cluster 101 has occurred. In some implementations, when a generation identifier is updated, a monotonically increasing number for the generation identifier of the cluster is used. Additionally, in some examples, only when the generation identifier obtained by a reporting node 102 is greater than the generation identifier known to peer node 102 does peer node 102 determine that a change in the cluster 101 has occurred. Upon detecting that a change in the cluster 101 has occurred, the heartbeat service 208 executing on the peer node 102 retrieves cluster data from the data store 206 that includes a listing of the nodes 102 of the cluster 101. The heartbeat service 208 retrieves the listing of the nodes 102 of the cluster 101 in the event that another node 102 has failed and has been removed from the cluster 101 or if a new node 102 has been added to the cluster 101. The heartbeat service 208 also determines whether there are unclaimed or orphaned shards 108 identified by the cluster data in the data store 206. If there are unclaimed shards 108 in the data store 206, the heartbeat service 208 on the node 102 can claim one or more of the orphaned shards 108 up to the shard assignment maximum policy associated with the cluster 101. If the heartbeat service 208 running on a respective node 102 claimed one or more orphaned shards 108 in the cluster 101, the heartbeat service 208 updates the generation identifier of the cluster 101, as the step of claiming orphaned shards 108 also represents a change to the state of the cluster 101. If the heartbeat service 208 does not claim any unclaimed shards 108, the heartbeat service 208 can select a new peer node 102 from the listing of nodes 102 to which the heartbeat service 208 reports status information. As the heartbeat service 208 running on the node 102 reports status information to its peer node 102, an updated generation identifier included therein triggers the peer node 102 to retrieve updated information about the cluster 101 from the data store 206. As that peer node 102 reports an updated status to its respective peer node 102, that respective peer node 102 will also retrieve updated information about the cluster 101 from the data store 206. As the updated generation identifier propagates around the cluster 101, all of the remaining nodes 102 will obtain updated cluster data from the data store 206 and select new peer nodes 102.

In some embodiments, a cluster 101 is configured by an administrator by specifying a shard assignment maximum policy and defining shards 108 in the data store 206. The administrator also adds nodes 102 to the cluster 101 by configuring a node 102 to access the cluster data in the data store 206 and executing the heartbeat service 208 on the node 102. As noted above, the data store 206 stores cluster data that describes the cluster 101. Cluster data includes information about a cluster 101 of nodes 102 that are deployed within a networked environment 200. Cluster data identifies, for example, the respective nodes 102 within the cluster 101 by a unique identifier. Cluster data includes which shards 108 are assigned to which nodes 102 within a cluster 101. Cluster data also identifies shards 108 that are unclaimed (or orphaned) shards 118, which are not assigned to any node 102 within the cluster 101. For example, the cluster data identifies respective shards 108 by a shard identifier that is calculated using a mathematical operation or a hash function along with an identifier of a node 102 assigned to the shard 108, if one is assigned to the shard 108. The assignment of shards 108 to nodes 102 can be represented by a table in the data store 206.

Cluster data in the data store 206 also specifies a generation identifier or a version number of the cluster 101. The nodes 102 within the cluster 101 determine whether the state of a cluster 101 has changed based upon the generation identifier, as is further described herein. Cluster data further includes the shard assignment maximum policy of the cluster 101.

The data store 206 is configured to allow only one node 102 to update the listing of nodes 102 or listing of shards 108 at any point in time for data integrity. In some implementations, a table or other structure in which cluster data is stored can utilize a pessimistic locking methodology so that only one node 102 in the cluster 101 can update the data store 206 at a time. A client 104 of the cluster 101 represents an application or device that is not a member of the cluster 101 and that submits requests to the cluster 101. The requests submitted by the client 104 represent requests for a node 102 of the cluster 101 to perform a task, such as processing or forwarding a message that is inbound from or outbound to a meter. For example, a client 104 represents a meter device management system running on behalf of a utility operator to manage a set of meters or receive metrology data from the set of meters. A client 104 could also represent a system that sends messages to meters or receives messages from meters on behalf of the meter device management system. A client 104 executes a heartbeat client 212. The heartbeat client 212 allows the client 104 to receive or observe the state of the cluster 101 as well as to obtain information about the cluster 101, or cluster data, from the data store 206. The heartbeat client 212 allows a client 104 to observe the health and status of a cluster 101 as well as to identify a node 102 within the cluster 101 to which requests, such as messages for transmission to a message destination 106, are sent.

In some embodiments, when an application running on the client 104 requires usage of the cluster 101, the application routes a request to the messaging queue 107 provided by the cluster 101. A node 102 of the cluster can retrieve the request from the messaging queue 107. The node 102 retrieving the request determines whether it is the correct node 102 to handle the request. If the node 102 receiving the request is the correct node 102 to handle the request, the node 102 processes the message. If the node 102 receiving the request is not the correct node 102 to handle the request, the node 102 forwards the request to the correct node 102 via a remote procedure call or an inter-process communication message. In some implementations, the client 104 routes a request directly to one of the nodes 102 of the cluster 101. The client 104 selects a node 102 of the cluster 101 either randomly or by selecting the node 102 assigned to handle a particular task based upon cluster status information obtained by the heartbeat client 212.

### Node Overview

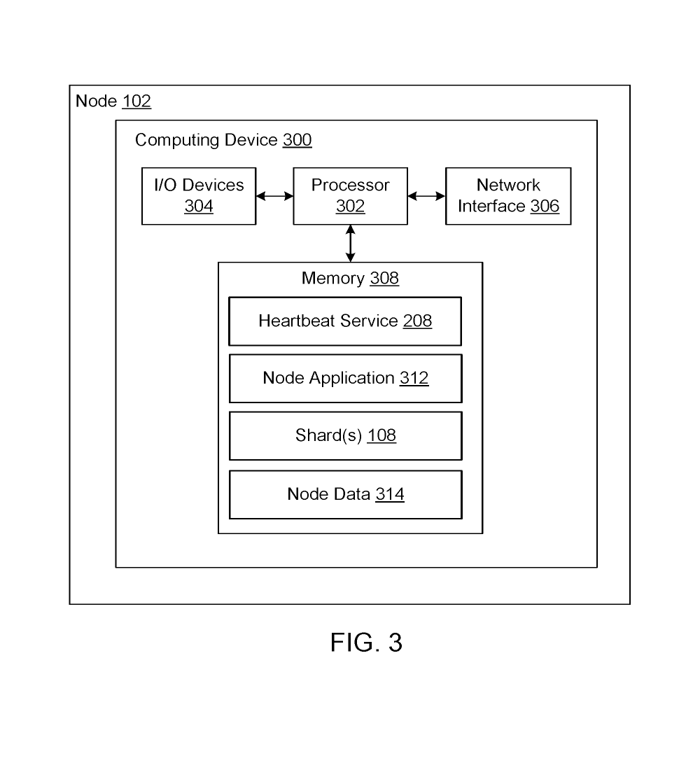

FIG. 3 illustrates node 102 according to various embodiments. In some embodiments the node 102 is a computing device 300. In some embodiments, one or more nodes 102 are utilized to form a cluster 101. Additionally, in some implementations, a node 102 is implemented as a virtual machine or a container such that multiple nodes 102 are implemented in a single computing device. As shown, the node 102 includes, without limitation, processor 302, I/O devices 304, one or more network interfaces 306, and memory 308, coupled together. Memory 308 includes, without limitation, heartbeat service 208, a node application 312, one or more shards 108, and node data 314.

Processor 302 coordinates operations of the node 102. In various embodiments, processor 302 includes any hardware configured to process data and execute software applications. The processor 302 can be any technically feasible processing device configured to process data and execute program instructions. For example, processor 302 could include one or more CPUs, DSPs, GPUs, ASICs, FPGAs, microprocessors, microcontrollers, other types of processing units, and/or a combination of different processing units.

I/O devices 304 include devices configured to receive input, devices configured to provide output, and devices configured to both receive input and provide output. The one or more network interfaces 306 are configured to receive messages and/or transmit messages from devices, such as clients 104 or message destinations 106 like meters or other computing devices associated with utility service providers.

Memory 308 includes any technically feasible storage device, such as a random-access memory (RAM) module, a flash memory unit, a hard disk drive, non-volatile storage, or any other type of memory unit or combination thereof. Memory 308 stores, without limitation, heartbeat service 208, one or more shards 108, node application 312 and node data 314.

Node data 314 includes information about the cluster 101, such as identifying information of the nodes 102 that are members of the cluster 101. Node data 314 also includes a listing of which shards 108 are assigned to which nodes 102 within the cluster 101 so that the node 102 can determine which node 102 should process a request received by the node 102. Node data 314 also includes information about the cluster 101 that is specific to the node 102. For example, node data 314 identifies a peer node 102 to which the node 102 reports status information. Node data 314 also identifies a reporting node 102 from which the node 102 receives status information. Node data 314 also identifies the data store 206 in which cluster data is stored so that a node 102 can access and update the data store 206 in the event of a failure of a reporting node 102 or if the node 102 claims unclaimed shards 108 that are identified in the data store 206.

When executed by processor 302, heartbeat service 208 on the node 102 performs various tasks. As described above in the discussion of FIG. 2, heartbeat service 208 adds nodes 102 to the cluster 101. Heartbeat service 208 also reports on the status of the node 102 to a peer node 102, which enables the peer node 102 to determine whether the node 102 has failed. Heartbeat service 208 also receives information about the status of a reporting node 102 and reports failure of a reporting node 102 to the data store 206. Additionally, in the event of a change in the status of the cluster 101, the heartbeat service 208 obtains updated cluster data including a listing of nodes 102 and information about shard 108 assignments, stored as node data 314 in the node 102, from the data store 206. The heartbeat service 208 also selects a new peer node 102 in the event of a change in the status of the cluster 101. The heartbeat service 208 also stores and updates cluster data retrieved from the data store 206 as node data 314. The heartbeat service 208 also detects when a given node 102 is marked as dead by the other nodes 102 in a cluster 101. When the heartbeat service 208 detects such a status, the heartbeat service 208 removes node 102 from the cluster 101. The heartbeat service 208 also periodically polls node data 314 to determine whether a node 102 becomes isolated from its peers due to network issues. For example, such a condition can be detected if the node 102 is marked dead within node data 314 by other nodes.

When executed by the processor 302, the node application 312 on the node 102 receives and processes requests from clients 104 of the cluster 101. The node application 312 represents an application or service that performs requested tasks that a node 102 is configured to perform on behalf of clients 104. For example, a meter infrastructure management system, in the role of a client 104 of the cluster 101, submits a request to a node 102 or the messaging queue 107 associated with the cluster 101. The request includes a message that the meter infrastructure management system is sending to a meter. The node application 312 forwards the message to the meter, or a message destination 106 via a network 110. In some instances, the node application 312 can perform other tasks other than routing messages to a message destination 106. For example, a task submitted to a node 102 can include a data processing task or data storage task that does not result in an outbound message being sent to a message destination 106.

Additionally, in some scenarios, the node application 312 running on a 102 within the cluster 101 receives a request that is associated with a shard 108 assigned to a different node 102. For example, the node 102 receives the request directly from a client 104 or from the messaging queue 107. The node application 312 determines, based on an identifier associated with the request, such as an IMEI of a meter that is a sender or recipient of a message, to which shard 108 the request is assigned. As one example, the node application 312 performs a modulo operation in which the identifier is divided by a divisor that is chosen to reflect a maximum number of possible shards 108 for assignment in the cluster 101. The remainder of the modulo operation is used as an identifier for the shards 108. For example, should a maximum number of ten shards be desired for a cluster 101, a modulus of the identifier associated with the request by ten is calculated, and the result of the operation identifies the shard 108 to which the request is assigned. The node data 314 obtained by the heartbeat service 208 identifies shards 108 by their respective identifiers as well as the node 102 to which the shards 108 are assigned. Accordingly, should a request received by a node 102 from a client 104 be assigned to a different node 102, the node application 312 receiving the request forwards the request to the node 102 that is responsible for the shard 108. The node application 312 running on the node 102 that receives the forwarded request can process the request by sending a message in the request to a message destination 106. The node 102 receiving the request from the client 104 forwards the request to the responsible node 102 via an inter-process communication or over a network with which the node 102 of the cluster 101 are communicatively coupled.

### Client Overview

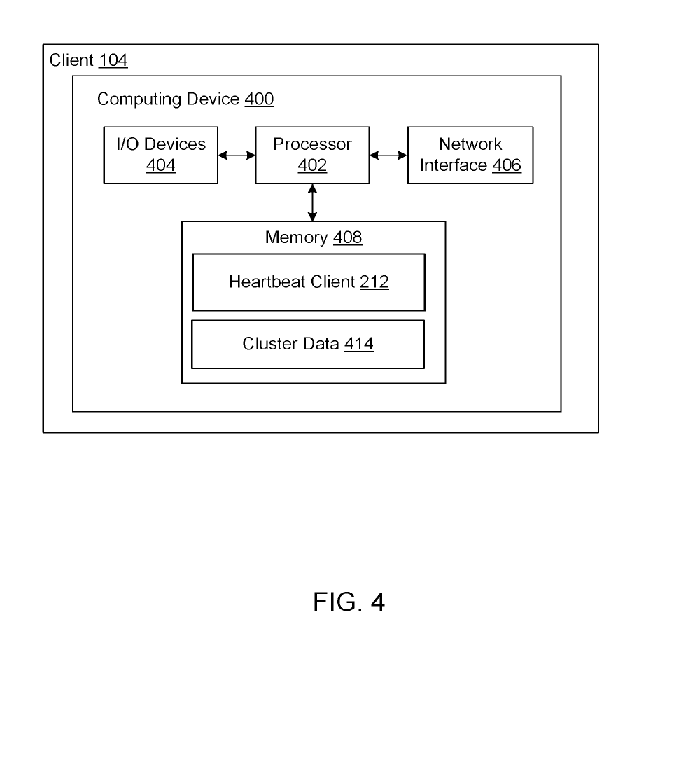

FIG. 4 illustrates client 104 according to various embodiments. In some embodiments the client 104 is a computing device 400. As shown, the client 104 includes, without limitation, processor 402, I/O devices 404, one or more network interfaces 406, and memory 408, coupled together. Memory 408 includes, without limitation, a heartbeat client 212 and cluster data 414.

Processor 402 coordinates operations of the client 104. In various embodiments, processor 402 includes any hardware configured to process data and execute software applications. The processor 402 can be any technically feasible processing device configured to process data and execute program instructions. For example, processor 402 could include one or more CPUs, DSPs, GPUs, ASICs, FPGAs, microprocessors, microcontrollers, other types of processing units, and/or a combination of different processing units.

I/O devices 404 include devices configured to receive input, devices configured to provide output, and devices configured to both receive input and provide output. The one or more network interfaces 406 are configured to receive messages and/or transmit messages from devices, such as nodes 102 of a node 102 or other computing devices associated with utility service providers.

Memory 408 includes any technically feasible storage device, such as a random-access memory (RAM) module, a flash memory unit, a hard disk drive, non-volatile storage, or any other type of memory unit or combination thereof. Memory 408 stores, without limitation, heartbeat client 212 and cluster data 414.

When executed by the processor 402, the heartbeat client 212 on the client 104 communicates with one or more nodes 102 of the cluster 101. The heartbeat client 212 also communicates with the data store 206 to retrieves cluster data associated with the cluster 101, which is stored as cluster data 414 on the client 104. The heartbeat client 212 allows a client 104 to observe the status of a cluster 101 and identify the nodes 102 that are operational as members of the cluster 101.

In one example, the heartbeat client 212 selects a node 102 in the cluster 101 from which status information is obtained. The status information is obtained from the heartbeat service 208 running on the selected node 102 and include the same information that a node 102 reports to a peer node 102. However, the heartbeat client 212 does not participate in detecting node 102 failure and cannot claim any shards 108. The heartbeat client 212 stores a generation identifier obtained from a node 102 and detects an update to the generation identifier when a change in the status of the cluster 101 occurs. Upon detecting an updated generation identifier, the heartbeat client 212 retrieves cluster data from the data store 206. In some embodiments, the heartbeat client 212 selects a node 102 from which to obtain status information randomly.

Using the cluster data 414, the heartbeat client 212 determines which nodes 102 are members of the cluster 101. In some embodiments, a client 104 can submit a request, such as a message to be routed to a message destination 106, directly to a node 102 within the cluster 101. The heartbeat service 208 running on the node 102 determines which node 102 in the cluster 101 is responsible for the shards 108 corresponding to the identifier associated with the request. The node 102 receiving the request either processes the request from the client 104 itself or routes the request to the responsible node 102 for the shard 108.

### Routing Requests within a Node

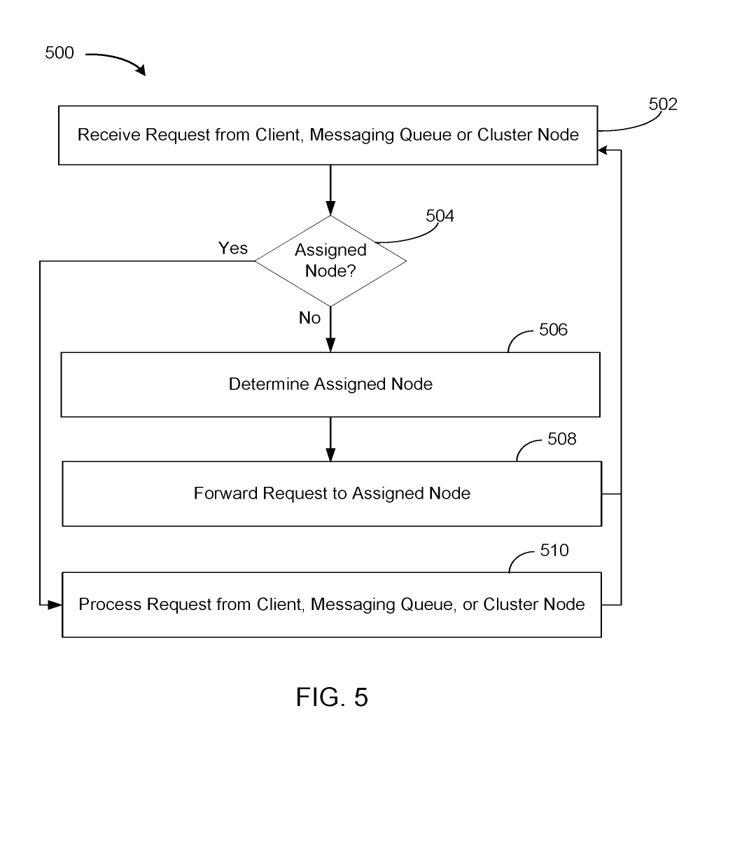

FIG. 5 is a flow diagram of method steps for a node 102 routing requests within the cluster 101, according to various embodiments. In some examples, the method 500 in FIG. 5 is implemented by a node application 312 executed by a node 102 in a cluster 101. Although the method steps are shown in an order, persons skilled in the art will understand that some method steps may be performed in a different order, repeated, and/or performed by components other than those described in FIG. 5. Although the method steps are described with respect to the systems of FIGS. 1-4, persons skilled in the art will understand that any system configured to perform the method steps, in any order, falls within the scope of the various embodiments.

As shown, method 500 begins at step 502, where node 102 within cluster 101 receives a request from the messaging queue 107 associated with the cluster 101. The request could also be received directly from a client 104 or from another node 102 in the cluster 101. In one example, the request includes a message that the client 104 is submitting to the cluster 101 so that the message can be forwarded to a message destination 106. For example, the message can include a management command from a meter infrastructure management system to a meter or a message including metrology data that is reported from a meter to the meter infrastructure management system.

At step 504, the node 102 determines whether the node 102 is assigned to a shard 108 associated with the request. The node 102 makes the determination based upon an identifier associated with the request. For example, the identifier includes an IMEI or other identifier associated with a meter that is the destination or sender of a message in the request. The node 102 can perform a mathematical operation on the identifier to calculate a shard identifier. The node 102 can then identify from node data 314 that is obtained from the data store 206 the node 102 that is assigned to the shard 108. If the node 102 receiving the request is assigned to the shard 108 with which the request is associated, the method 500 proceeds to step 510. Otherwise, the method 500 proceeds to step 506.

At step 506, the node 102 determines the assigned node 102 based on the request. For example, the node 102 identifies another node 102 in the cluster 101 that is assigned to the shard 108 with which the identifier is associated. The node 102 identifies the assigned node 102, or a responsible node 102, based upon the node data 314, which is populated with cluster data that the heartbeat service 208 obtains from the data store 206.

At step 508, the node 102 forwards the request received at step 502 to the assigned node 102 identified at step 506. The node 102 forwards the request over a network to which the nodes 102 in the cluster 101 are connected or via an inter-process communication message supported by the nodes 102. From step 508, the method 500 returns to step 502, where the node 102 awaits another request from a client 104, the messaging queue 107, or another node 102 of the cluster 101.

At step 510, the node 102 processes the request received from a client 104, the messaging queue 107, or another node 102 in the cluster 101. For example, the node 102 forwards a message embedded in the request to a message destination 106 specified in the request. From step 510, the method 500 returns to step 502, where the node 102 awaits another request from a client 104, the messaging queue 107, or another node 102 of the cluster 101.

### Adding Node to a Cluster

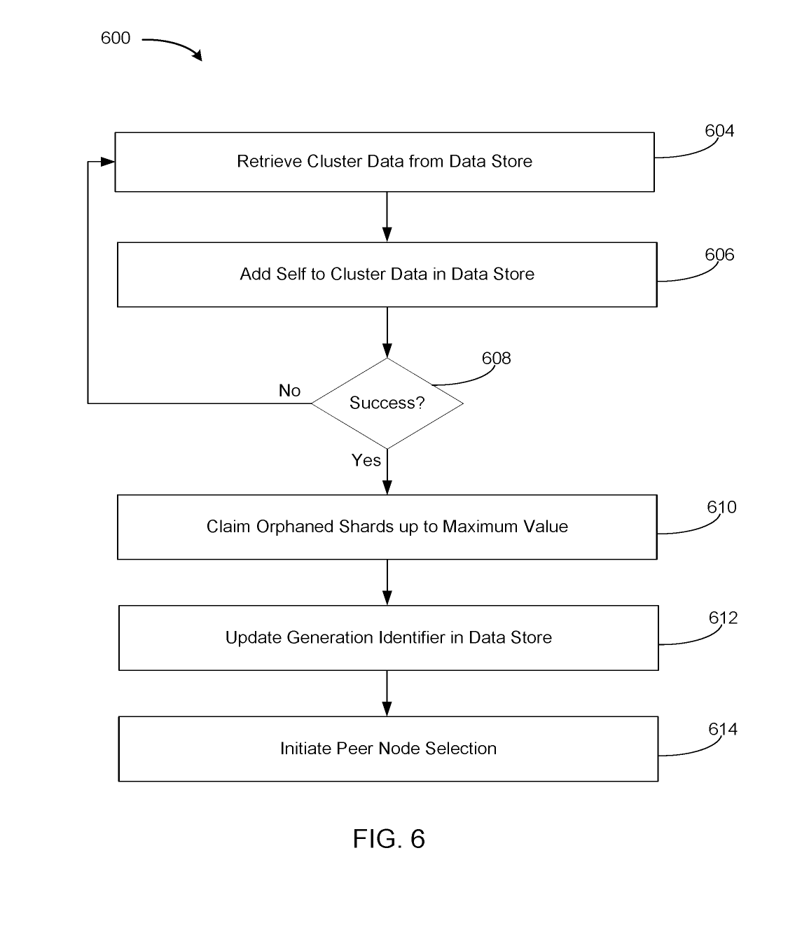

FIG. 6 is a flow diagram of method steps for adding a node to a cluster, according to various embodiments, according to various embodiments. In some examples, the method 600 in FIG. 6 is implemented by a heartbeat service 208 executed by a node 102 in a cluster 101. Although the method steps are shown in an order, persons skilled in the art will understand that some method steps may be performed in a different order, repeated, and/or performed by components other than those described in FIG. 6. Although the method steps are described with respect to the systems of FIGS. 1-4, persons skilled in the art will understand that any system configured to perform the method steps, in any order, falls within the scope of the various embodiments.

As shown, the method 600 begins at step 604, where the node 102 retrieves cluster data from the data store 206 in which information about the cluster 101 is stored. The cluster data includes, for example, a listing of nodes 102 that are members of the cluster 101, a shard assignment maximum policy for the cluster 101, and an assignment of shards 108 to nodes 102 within the cluster, which can also include an indication that certain shards 108 are unassigned or orphaned.

At step 606, the node 102 adds itself to the cluster 101. For example, heartbeat service 208 running on the node 102 adds an identifier corresponding to the node 102 to a listing of nodes 102 in the cluster data stored in the data store 206. The listing of nodes 102 can include a network address of the node 102 as well as a unique alphanumeric identifier of the node 102 that is assigned by an administrator or generated by the heartbeat service 208.

At step 608, the node 102 determines whether adding itself to the listing of nodes 102 within the data store 206 was successful. In some instances, multiple nodes 102 can attempt to update the cluster data in the data store 206 simultaneously. In this scenario, the data store 206 is configured to allow only one node 102 to update the listing of nodes 102 at any point in time for data integrity. In some implementations, a table or other structure in which cluster data is stored can utilize a pessimistic locking methodology so that only one node 102 in the cluster 101 can update the data store 206 at a time. If the heartbeat service 208 was unsuccessful in adding the node 102 to the cluster 101, the heartbeat service 208 can wait a random amount of time and return to step 604. If the heartbeat service 208 was successful in adding the node 102 to the cluster 101, the method 600 proceeds to step 610.

At step 610, the node 102 claims one or more shards 108 that are indicated as unclaimed or orphaned in the data store 206. The heartbeat service 208 claims the shards 108 by updating a table or listing of shards 108 to indicate that the node 102 on which the heartbeat service 208 is running is assigned to the shards 108.

At step 612, the node 102 updates a generation identifier in the data store 206 associated with the cluster 101. For example, heartbeat service 208 increments the generation identifier. The updating of the generation identifier signals to other nodes 102 in the cluster 101 that a change to the cluster 101 has occurred. In the context of the method 600, the change to the cluster 101 is the addition of the node 102 to the cluster 101.

At step 614, the node 102 initiates selection of a peer node 102 from the cluster 101. In some embodiments, the heartbeat service 208 sorts a listing of the node 102 of the cluster 101 by their respective alphanumeric identifiers and selects a next or previous node 102 in the sorted listing as its peer node 102. The nodes 102 can subsequently report status information to the selected peer node 102.

### Responding to a Change in the Cluster

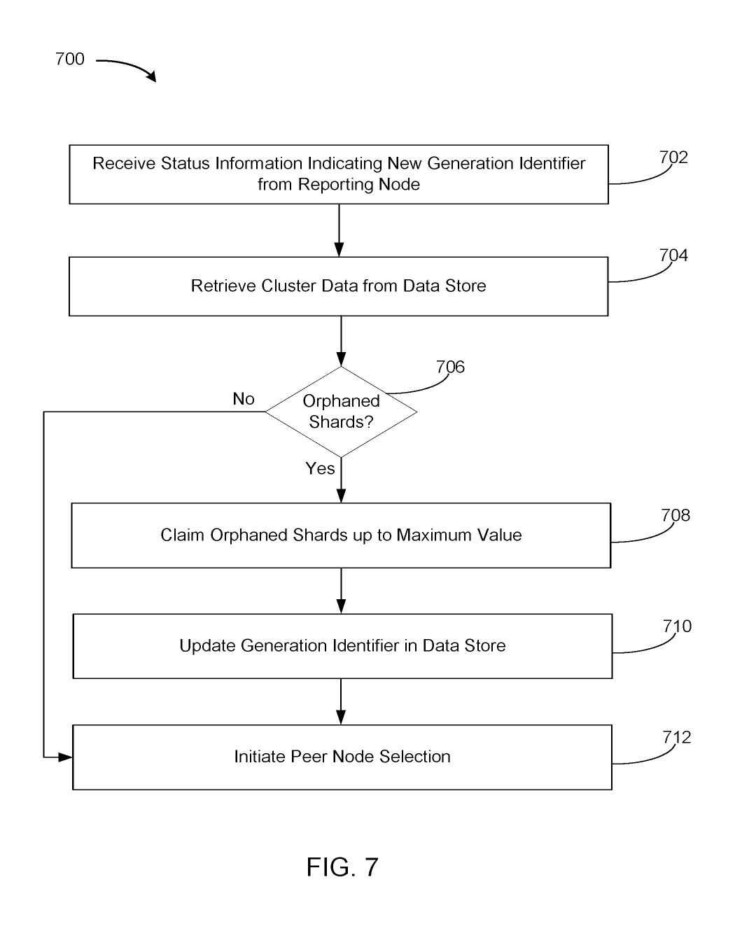

FIG. 7 is a flow diagram of method steps for a node receiving and processing updated cluster status information, according to various embodiments. In some examples, the method 700 in FIG. 7 is implemented by a heartbeat service 208 executed by a node 102 in a cluster 101. Although the method steps are shown in an order, persons skilled in the art will understand that some method steps may be performed in a different order, repeated, and/or performed by components other than those described in FIG. 7. Although the method steps are described with respect to the systems of FIGS. 1-4, persons skilled in the art will understand that any system configured to perform the method steps, in any order, falls within the scope of the various embodiments.

The method 700 begins at step 702, where the heartbeat service 208 receives status information indicating a new generation identifier from a reporting node 102. The new or updated generation identifier that indicates that a change in the cluster 101 has occurred.

At step 704, the node 102 retrieves cluster data from the data store 206. The cluster data includes a listing of nodes 102 in the cluster 101, which indicates whether any nodes 102 that were previously in the cluster 101 are no longer members of the node 102. The cluster data also includes shard 108 assignments, which indicates whether any nodes 102 are assigned to different shards 108, or vice versa.

At step 706, the node 102 determines whether there are orphaned shards 108 in the cluster data. If a node 102 previously in the cluster 101 is no longer operational or has been marked as a dead node 102, the node 102 claims one or more orphaned shards 108 so that tasks associated with the unclaimed or orphaned shards 108 can be reassigned or other nodes 102. If there are no unclaimed shards 108 in the cluster 101, the method 700 proceeds to step 712. Otherwise, the method 700 proceeds to step 708.

At step 708, the heartbeat service 208 claims one or more orphaned shards 108 up to a shard assignment maximum policy. As noted above, nodes 102 can be limited to a maximum number of shards 108 to prevent any one node 102 from becoming overloaded with requests submitted by clients 104 of the cluster 101.

At step 710, the node 102 updates the generation identifier in the data store 206 to reflect a change in the node 102. By claiming one or more unclaimed shards 108 the heartbeat service 208 causes a change in the node 102.

At step 712, the node 102 initiates selection of a peer node 102 from the cluster 101. As noted above, in some examples, the heartbeat service 208 sorts a listing of the node 102 of the cluster 101 by their respective alphanumeric identifiers and selects a next or previous node 102 in the sorted listing as its peer node 102. The nodes 102 can subsequently report status information to the selected peer node 102.

### Issuing Heartbeat Requests to Nodes

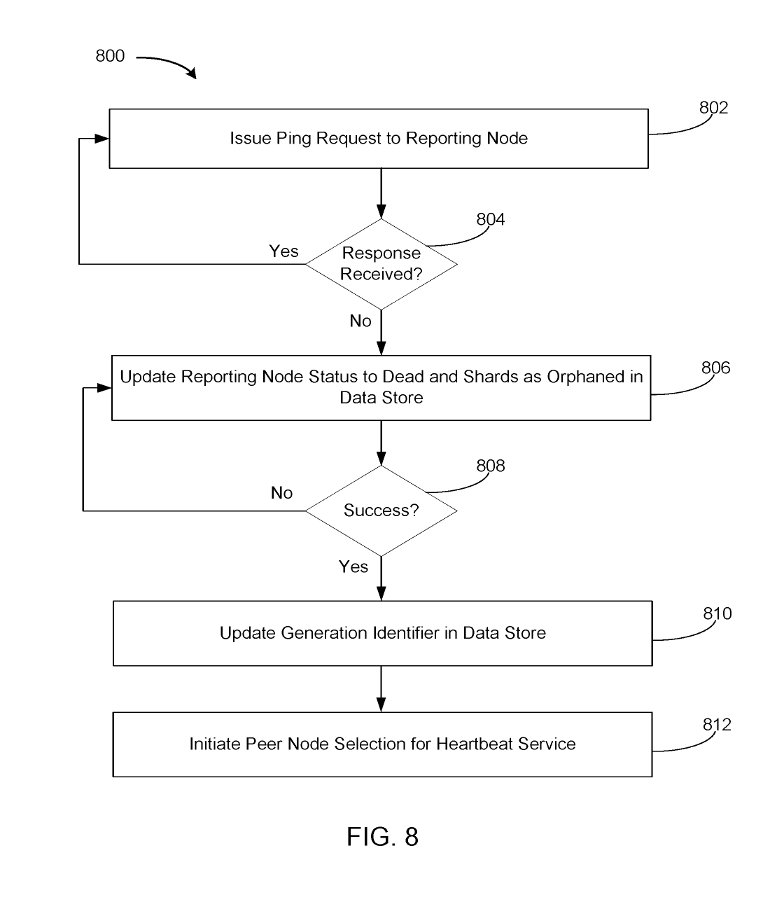

FIG. 8 is a flow diagram of method steps for a node issuing ping requests to a reporting node, according to various embodiments. In some examples, the method 800 in FIG. 8 is implemented by a heartbeat service 208 executed by a node 102 in a cluster 101. Although the method steps are shown in an order, persons skilled in the art will understand that some method steps may be performed in a different order, repeated, and/or performed by components other than those described in FIG. 8. Although the method steps are described with respect to the systems of FIGS. 1-4, persons skilled in the art will understand that any system configured to perform the method steps, in any order, falls within the scope of the various embodiments.

The method 800 begins at step 802, where the node 102 issues a ping request to a reporting node 102. As noted above, a reporting node 102 is a node 102 in the cluster 101 from which a node 102 receives status information. A peer node 102 is a node 102 in the cluster 101 to which a 102 reports status information.

At step 804, the node 102 determines whether the reporting node 102 issues a response to the ping request. A response to the ping request indicates that the reporting node 102 is still operational as a node 102 within the cluster 101. In some implementations, the reporting node 102 can send a response indicating that the reporting node 102 is no longer operational as a node 102 within the cluster 101. If the heartbeat service 208 receives a response that indicates that the reporting node 102 is operational, the process waits a predetermined period of time between ping requests and returns to step 802. Otherwise, the heartbeat service 208 determines that the reporting node 102 is dead, and the method 800 proceeds to step 806.

At step 806, the node 102208 updates the reporting node 102 status to dead in the cluster data stored in the data store 206. Additionally, the node 102 marks the shards 108 previously assigned to the reporting node 102 as unassigned or orphaned.

At step 808, the node 102 determines whether updating the cluster data in the data store 206 at step 806 was successful. As noted above, the data store 206 is configured to allow only one node 102 to update the listing of nodes 102 or listing of shards 108 at any point in time for data integrity purposes. If the updating of the data store 206 was unsuccessful, the heartbeat service 208 waits a predetermined period of time that can be randomly generated and returns to step 806, where the node 102 retries updating the data store 206. If updating the data store 206 was successful, the method proceeds to step 810.

At step 810, the node 102 updates the generation identifier in the data store 206 to reflect a change in the node 102. By claiming one or more unclaimed shards 108 the node 102 causes a change in the node 102.

At step 812, the node 102 initiates selection of a peer node 102 from the cluster 101. As noted above, in some examples, the heartbeat service 208 sorts a listing of the node 102 of the cluster 101 by their respective alphanumeric identifiers and selects a next or previous node 102 in the sorted listing as its peer node 102. The nodes 102 can subsequently report status information to the selected peer node 102.

### System Overview

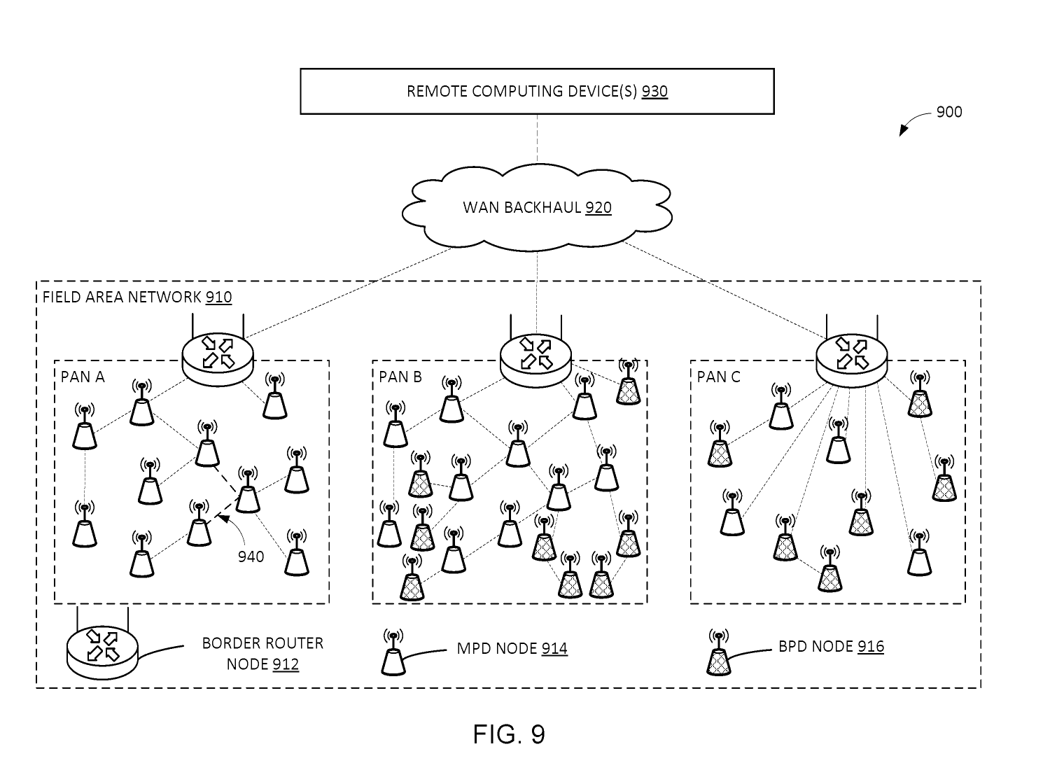

FIG. 9 illustrates a network system configured to implement one or more aspects of the various embodiments. As shown, network system 900 includes a field area network (FAN) 910, a wide area network (WAN) backhaul 920, and one or more remote computing devices 930. FAN 910 is coupled to remote computing device(s) 930 via WAN backhaul 920.

FAN 910 includes personal area network (PANs) A, B, and C. PANs A and B are organized according to a mesh network topology, while PAN C is organized according to a star network topology. Each of PANs A, B, and C includes various network devices including at least one border router node 912 and one or more mains-powered device (MPD) nodes 914. PANs B and C further include one or more battery-powered device (BPD) nodes 916. Any of the one or more MPD nodes 914 or the BPD nodes 916 can be used to implement the techniques discussed above with respect to FIGS. 1-8. In various embodiments, nodes 914 or 916 can be implemented as nodes 102, clients 104 or message destinations 106. In some embodiments, nodes 914 or 916 can be implemented as some other suitable communication devices, such as streetlights. FAN 910 and WAN backhaul 920 can be implemented as a portion of network 110.

MPD nodes 914 draw power from an external power source, such as mains electricity or a power grid. MPD nodes 914 typically operate on a continuous basis without powering down for extended periods of time. BPD nodes 916 draw power from an internal power source, such as a battery. BPD nodes 916 typically operate intermittently and power down, go to very low power mode, for extended periods of time in order to conserve battery power.

MPD nodes 914 and BPD nodes 916 are coupled to, or included within, a utility distribution infrastructure (not shown) that distributes a resource to consumers. MPD nodes 914 and BPD nodes 916 gather sensor data related to the distribution of the resource, process the sensor data, and communicate processing results and other information to remote computing device(s) 930. Border router nodes 912 operate as access points to provide MPD nodes 914 and BPD nodes 916 with access to remote computing device(s) 930.

Any of border router nodes 912, MPD nodes 914, and BPD nodes 916 are configured to communicate directly with one or more adjacent nodes via bi-directional communication links 940. The communication links 940 may be wired or wireless links, although in practice, adjacent nodes of a given PAN exchange data with one another by transmitting data packets via wireless radio frequency (RF) communications. The various node types are configured to perform a technique known in the art as “channel hopping” in order to periodically receive data packets on varying channels. As known in the art, a “channel” may correspond to a particular range of frequencies. In one embodiment, a node may compute a current receive channel by evaluating a Jenkins hash function based on a total number of channels and the media access control (MAC) address of the node.

In some examples, MPD nodes 914 or BPD nodes 916 can communicate directly with remote computing devices 930 via respective cellular communication links. In such examples, MPD nodes 914 or BPD nodes 916 can transmit messages to and/or receive messages from remote computing devices 930 without using border router nodes 912. Furthermore, in some examples, remote computing devices 930 are implemented as MPD nodes 914 or BPD nodes 916. In such examples, MPD nodes 914 and BPD nodes 916 can perform the control and/or data analysis functions described herein with respect to remote computing devices 930.

In some examples, each node within a given PAN can implement a discovery protocol to identify one or more adjacent nodes or “neighbors.” A node that has identified an adjacent, neighboring node can establish a bi-directional communication link 940 with the neighboring node. Each neighboring node may update a respective neighbor table to include information concerning the other node, including one or more of the MAC address of the other node, listening schedule information for the other node, a received signal strength indication (RSSI) of the communication link 940 established with that node, and the like.

Nodes can compute the channel hopping sequences of adjacent nodes to facilitate the successful transmission of data packets to those nodes. In embodiments where nodes implement the Jenkins hash function, a node computes a current receive channel of an adjacent node using the total number of channels, the MAC address of the adjacent node, and a time slot number assigned to a current time slot of the adjacent node.

Any of the nodes discussed above may operate as a source node, an intermediate node, or a destination node for the transmission of data packets. A given source node can generate a data packet and then transmit the data packet to a destination node via any number of intermediate nodes (in mesh network topologies). The data packet can indicate a destination for the packet and/or a particular sequence of intermediate nodes to traverse in order to reach the destination node. In one embodiment, each intermediate node can include a forwarding database indicating various network routes and cost metrics associated with each route.

Nodes can transmit messages and/or data packets across a given PAN and across WAN backhaul 920 to remote computing device(s) 930. Similarly, remote computing device(s) 930 can transmit messages and/or data packets across WAN backhaul 920 and across any given PAN to a particular node included therein. As a general matter, numerous routes can exist which traverse any of PANs A, B, and C and include any number of intermediate nodes, thereby allowing any given node or other component within network system 900 to communicate with any other node or component included therein.

Remote computing device(s) 930 includes one or more server machines (not shown) or other computing devices configured to operate as sources for, or destinations of, messages and/or data packets that traverse within network system 900. The server machines can query nodes within network system 900 to obtain various data, including raw or processed sensor data, power consumption data, node/network throughput data, status information, and so forth. The server machines can also transmit commands and/or program instructions to any node within network system 900 to cause those nodes to perform various operations. In one embodiment, each server machine is a computing device configured to execute, via a processor, a software application stored in a memory to perform various network management and/or earthquake classification operations. In various embodiments, a client 104 and node 102 are implemented as remote computing device(s) 930.

In sum, techniques are disclosed herein that enable management of workloads within a cluster. According to various embodiments a message from a client is obtained by a node in a cluster of nodes. The node determines a shard within the cluster that corresponds to the message based upon an identifier included in the message and a responsible node associated with the shard. The node also forwards the message to the responsible node, and the responsible node delivers the message to a destination.

At least one technical advantage of the disclosed embodiments is the simplicity of implementation. Workloads can be associated with an identifier of a meter or other type of endpoint device. As a result, workloads are efficiently assigned to a shard within a cluster. In addition, nodes of the cluster can efficiently and accurately determine which node within a cluster should receive a workload to perform. Another technical advantage of the disclosed embodiments is that few external dependencies are needed to effectively distribute workloads among nodes. Another technical advantage of the disclosed embodiments is that a cluster of nodes according to the disclosure is self-governing and does not need a leader node in order to operate effectively.

1. In some embodiments, a method comprises obtaining, by a node in a cluster of nodes, a message from a queue, determining, by the node, a shard within the cluster that corresponds to the message based upon an identifier included in the message, determining, by the node, a responsible node associated with the shard, and forwarding, by the node, the message to the responsible node, wherein the responsible node delivers the message to a destination.

2. The method of clause 1, wherein determining the shard within the cluster that corresponds to the message comprises performing a mathematical operation on an identifier associated with a sender or a recipient of the message, and identifying the shard based on a result of the mathematical operation.

3. The method of clauses 1 or 2, wherein the mathematical operation comprises a modulo operation and the result of the modulo operation comprises an identifier of the shard.

4. The method of any of clauses 1-3, further comprising sending, by the node, first status information associated with the node to a peer node within the cluster of nodes, the first status information comprising an indication that the node is operating, and receiving, by the node, second status information associated with a reporting node within the cluster of nodes, the second status information comprising an indication that the reporting node is operating, wherein the peer node and the reporting node are different nodes in the cluster of nodes.

5. The method of any of clauses 1-4, further comprising transmitting, by the node, a request for first status information from a reporting node in the cluster of nodes, determining, by the node in response to the reporting node not responding to the request or the reporting node returning an error code, that the reporting node is a failed node, and updating, by the node, cluster data in a data store to reflect that the reporting node is a failed node.

6. The method of any of clauses 1-5, further comprising updating, by the node, a generation identifier associated with the cluster in the cluster data.

7. The method of any of clauses 1-6, further comprising initiating, by the node, selection of a new peer node in the cluster of nodes in response to updating the generation identifier.

8. The method of any of clauses 1-7, further comprising identifying, by the node, an unclaimed shard within the cluster based on cluster data stored in a data store, claiming, by the node, the unclaimed shard by updating the cluster data stored in the data store, and updating, by the node, a generation identifier associated with the cluster in the cluster data.

9. The method of any of clauses 1-8, further comprising receiving, by the node, a generation identifier from a reporting node in the cluster of nodes, determining, by the node and based on the generation identifier, that a change in the cluster of nodes has occurred, retrieving, by the node in response to determining that the change in the cluster of nodes has occurred, cluster data from a data store, the cluster data identifying the nodes in the cluster, and selecting, by the node and based upon the cluster data, a peer node.

10. The method of any of clauses 1-9, wherein selecting the peer node comprises sorting, by the node, a listing of the nodes of the cluster by respective identifiers of the nodes, and selecting a next or previous node in the sorted listing of the nodes as the peer node.

11. In some embodiments, a computing device in a cluster, the computing device comprises one or more processors, and a memory storing executable instructions that, when executed by the one or more processors, cause the one or more processors to perform operations comprising receiving a message from a messaging queue, identifying a responsible node for the message based upon an identifier included in the message, and forwarding, by the computing device, the message to the responsible node, wherein the responsible node delivers the message to a destination identified in the message.

12. The computing device of clause 11, wherein identifying the responsible node comprises identifying a shard to which the identifier corresponds, wherein the shard is associated with a plurality of destinations based on respective identifiers of the plurality of destinations.

13. The computing device of clauses 11 or 12, wherein the identifier comprises an international mobile equipment identity (IMEI) number assigned to a meter in a utility metering environment.

14. The computing device of any of clauses 11-13, wherein the operations further comprise sending, a first heartbeat message associated with the computing device to a peer node within the cluster, the first heartbeat message comprising an indication that the computing device is operational as a node within the cluster, and receiving a second heartbeat message associated with a reporting node within the cluster, the second heartbeat message comprising an indication that the reporting node is operational, wherein the peer node and the reporting node are different nodes in the cluster.

15. The computing device of any of clauses 11-14, wherein the operations further comprise prior to receiving the message from the messaging queue, adding a node identifier identifying the computing device to a listing of nodes in the cluster, and claiming at least one orphaned shard associated with the cluster.

16. The computing device of any of clauses 11-15, wherein the responsible node comprises a virtual machine or a container.

17. In some embodiments, one or more non-transitory computer-readable media store instructions which, when executed by one or more processors of a node device of a cluster, cause the one or more processors to perform operations comprising receiving a message from a client device of the cluster, identifying a shard within the cluster based upon an identifier of a sender or recipient of the message, identifying an assigned node device associated with the shard, and sending the message to the assigned node device, wherein the assigned node device delivers the message to a destination.

18. The one or more non-transitory computer-readable media of clause 17, wherein the operations further comprise sending first status information associated with the node device to a peer node device within the cluster, the first status information comprising an indication that the node device is operational, and receiving second status information associated with a reporting node device within the cluster of node devices, the second status information comprising an indication that the reporting node device is operational, wherein the peer node device and the reporting node device are different node devices in the cluster.

19. The one or more non-transitory computer-readable media of clauses 17 or 18, wherein the operations further comprise identifying an unclaimed shard within the cluster based on cluster data stored in a data store, claiming the unclaimed shard by updating the cluster data stored in the data store, and updating a generation identifier associated with the cluster in the cluster data.

20. The one or more non-transitory computer-readable media of any of clauses 17-19, wherein the operations further comprise receiving a generation identifier from a reporting node device in the cluster, determining, based on the generation identifier, that a change in the cluster has occurred, retrieving cluster data from a data store, the cluster data identifying node devices in the cluster, and selecting, based upon the cluster data, a peer node device.

Any and all combinations of any of the claim elements recited in any of the claims and/or any elements described in this application, in any fashion, fall within the contemplated scope of the present protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module,” a “system,” or a “computer.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow. Moreover, in the above description, numerous specific details are set forth to provide a more thorough understanding of the various embodiments. However, it will be apparent to one of skill in the art that the inventive concepts may be practiced without one or more of these specific details.

What is claimed is:

1. A method comprising:
obtaining, by a node in a cluster of nodes, a message from a queue;
determining, by the node, a shard within the cluster that corresponds to the message based upon an identifier included in the message;
determining, by the node, a responsible node associated with the shard; and
forwarding, by the node, the message to the responsible node, wherein the responsible node delivers the message to a destination.

2. The method of claim 1, wherein determining the shard within the cluster that corresponds to the message comprises:
performing a mathematical operation on an identifier associated with a sender or a recipient of the message; and
identifying the shard based on a result of the mathematical operation.

3. The method of claim 2, wherein the mathematical operation comprises a modulo operation and the result of the modulo operation comprises an identifier of the shard.

4. The method of claim 1, further comprising:
sending, by the node, first status information associated with the node to a peer node within the cluster of nodes, the first status information comprising an indication that the node is operating; and
receiving, by the node, second status information associated with a reporting node within the cluster of nodes, the second status information comprising an indication that the reporting node is operating, wherein the peer node and the reporting node are different nodes in the cluster of nodes.

5. The method of claim 1, further comprising:
transmitting, by the node, a request for first status information from a reporting node in the cluster of nodes;
determining, by the node in response to the reporting node not responding to the request or the reporting node returning an error code, that the reporting node is a failed node; and
updating, by the node, cluster data in a data store to reflect that the reporting node is a failed node.

6. The method of claim 5, further comprising updating, by the node, a generation identifier associated with the cluster in the cluster data.

7. The method of claim 6, further comprising:
initiating, by the node, selection of a new peer node in the cluster of nodes in response to updating the generation identifier.

8. The method of claim 1, further comprising:
identifying, by the node, an unclaimed shard within the cluster based on cluster data stored in a data store;
claiming, by the node, the unclaimed shard by updating the cluster data stored in the data store; and
updating, by the node, a generation identifier associated with the cluster in the cluster data.

9. The method of claim 1, further comprising:
receiving, by the node, a generation identifier from a reporting node in the cluster of nodes;
determining, by the node and based on the generation identifier, that a change in the cluster of nodes has occurred;
retrieving, by the node in response to determining that the change in the cluster of nodes has occurred, cluster data from a data store, the cluster data identifying the nodes in the cluster; and
selecting, by the node and based upon the cluster data, a peer node.

10. The method of claim 9, wherein selecting the peer node comprises:
sorting, by the node, a listing of the nodes of the cluster by respective identifiers of the nodes; and
selecting a next or previous node in the sorted listing of the nodes as the peer node.

11. A computing device in a cluster, the computing device comprising:
one or more processors; and a memory storing executable instructions that, when executed by the one or more processors, cause the one or more processors to perform operations comprising:
receiving a message from a messaging queue; identifying a responsible node for the message based upon an identifier included in the message; and
forwarding, by the computing device, the message to the responsible node, wherein the responsible node delivers the message to a destination identified in the message.

12. The computing device of claim 11, wherein identifying the responsible node comprises identifying a shard to which the identifier corresponds, wherein the shard is associated with a plurality of destinations based on respective identifiers of the plurality of destinations.

13. The computing device of claim 11, wherein the identifier comprises an international mobile equipment identity (IMEI) number assigned to a meter in a utility metering environment.

14. The computing device of claim 11, wherein the operations further comprise:
sending, a first heartbeat message associated with the computing device to a peer node within the cluster, the first heartbeat message comprising an indication that the computing device is operational as a node within the cluster; and
receiving a second heartbeat message associated with a reporting node within the cluster, the second heartbeat message comprising an indication that the reporting node is operational, wherein the peer node and the reporting node are different nodes in the cluster.

15. The computing device of claim 11, wherein the operations further comprise:
prior to receiving the message from the messaging queue, adding a node identifier identifying the computing device to a listing of nodes in the cluster; and
claiming at least one orphaned shard associated with the cluster.

16. The computing device of claim 11, wherein the responsible node comprises a virtual machine or a container.

17. One or more non-transitory computer-readable media storing instructions which, when executed by one or more processors of a node device of a cluster, cause the one or more processors to perform operations comprising:
receiving a message from a client device of the cluster;
identifying a shard within the cluster based upon an identifier of a sender or recipient of the message;
identifying an assigned node device associated with the shard; and
sending the message to the assigned node device, wherein the assigned node device delivers the message to a destination.

18. The one or more non-transitory computer-readable media of claim 17, wherein the operations further comprise:
sending first status information associated with the node device to a peer node device within the cluster, the first status information comprising an indication that the node device is operational; and
receiving second status information associated with a reporting node device within the cluster of node devices, the second status information comprising an indication that the reporting node device is operational, wherein the peer node device and the reporting node device are different node devices in the cluster.

19. The one or more non-transitory computer-readable media of claim 17, wherein the operations further comprise:
identifying an unclaimed shard within the cluster based on cluster data stored in a data store; claiming the unclaimed shard by updating the cluster data stored in the data store; and
updating a generation identifier associated with the cluster in the cluster data.

20. The one or more non-transitory computer-readable media of claim 17, wherein the operations further comprise:
receiving a generation identifier from a reporting node device in the cluster;
determining, based on the generation identifier, that a change in the cluster has occurred;
retrieving cluster data from a data store, the cluster data identifying node devices in the cluster; and
selecting, based upon the cluster data, a peer node device.
